(19) United States
(12) Patent Application Publication
(10) Pub. No.: US 2009/0080316 A1
(43) Pub. Date: Mar. 26, 2009

(54) Optical Information Recording and/or Reproducing Apparatus

(76) Inventor: Masahiko Takahashi, Uenohara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/235,661

(22) Filed: Sep. 23, 2008

(30) Foreign Application Priority Data
Sep. 25, 2007 (JP) 2007-247832

(51) Int. Cl. G11B 7/00

(52) U.S. Cl. 369/103; G9B/7

(57) ABSTRACT

An optical information recording and/or reproducing apparatus is provided which can, with the help of the same apparatus, record information on both an information recording area of an information recording medium for hologram and an information recording area of an existing optical disc typified by BD, DVD or CD and/or reproduce the information recorded on both the information recording areas. The optical information recording and/or reproducing apparatus performs recording and/or reproduction of information on and/or from a hologram memory disc and an optical disc by means of an optical pickup and has a stepping motor for driving the hologram memory disc and a DC motor for driving the optical disc.

### INCORPORATION BY REFERENCE

The present application claims priority from Japanese application JP-2007-247832 filed on Sep. 25, 2007, the content of which is hereby incorporated by reference into this application.

### BACKGROUND OF THE INVENTION

The present invention relates to an optical information recording and/or reproducing apparatus for recording information on both an information recording medium for hologram and an optical disc typified by CD (Compact Disc), DVD (Digital Versatile Disc), Blue-ray Disc and the like adapted to perform recording and/or reproducing the information during its high-speed rotation, for reproducing information recorded on both the medium and the optical disc or for performing both recording and reproduction of the information.

An optical information recording and/or reproducing apparatus has hitherto been available which records information on an information recording area (information recording surface) of an optical information recording medium (optical disc) such as CD, DVD and the like and/or reproduces the information recorded on the information recording area. One may refer to, for example, JP-A-2005-276312 as disclosing this type of optical information recording and/or reproducing apparatus, according to which an optical pickup is arranged movably between, for example, two optical discs spaced apart to oppose to each other.

In recent years, following the standards of a Blue-ray Disc (hereinafter referred to as BD) using a blue-violet semiconductor laser or the standards of a HD-DVD (High Definition Digital Versatile Disc), an optical disc having a recording density of about 50 GB can be commercialized even for consumer. Then, the optical disc has been desired to be further increased in capacity, amounting up to be comparable to 100 GB to 1 TB of HDD (Hard Disc Drive) capacity.

However, to realize such a super high density in the optical disc, there needs a new storage technique different from the conventional high-density technique having resort by now to shortening of wavelength and high NA of objective lens. Under the circumstances, a hologram recording technique of recording digital information by utilizing holography has been highlighted recently. In the hologram recording technique, pieces of two-dimensional information can be recorded/reproduced at a time by means of one hologram and besides, plural pieces of page data can be over written at the same location and therefore, this kind of technique finds efficiency in recording/reproduction of information of large capacity and high speed.

Available as the hologram recording technique is a so-called angular multiplex recording scheme disclosed in, for example, JP-A-2004-272268 in which concurrently with focusing signal luminance flux on an optical information recording medium by means of a lens, a reference light beam of collimated luminance flux is irradiated to interfere with the signal luminance flux so as to perform recording of a hologram and besides, while changing the incident angle of the reference luminance beam on the optical recording medium, different pieces of page data are displayed on a space light modulator to thereby carry out multiplex recording.

Another hologram recording technique based on a shift multiplex scheme has also been introduced as disclosed in, for example, WO 2004-102542, according to which in a single space light modulator, a light beam from inner pixels and a light beam from outer annular pixels are used as a signal beam and a reference beam, respectively, and the two luminance flux rays are focused on a light recording medium by means of the same lens to cause the signal beam and the reference beam to interfere with each other near a focal plane of the lens, thus recording a hologram.

In the optical information recording/reproducing apparatus utilizing the hologram, it is desirable from the standpoint of upward compatibility that the conventional discs typified by BD, DVD and so on can be recorded or reproduced with the same apparatus. In the past, the optical information recording/reproducing apparatus which records information on an information recording area of, for example, DVD and BD and/or reproduces the information recorded on the information recording area has been introduced but an information recording/reproducing apparatus for consumer has not been introduced which records information on both information recording areas of an information recording medium for hologram and a conventional optical disc and/or reproduces the information from the information recording areas.

Further, the optical information recording/reproducing apparatus described in, for example, JP-A-2005-276312 accommodates two optical discs and records and/or reproduces information on/from the optical discs but the Patent Document fails to describe a concrete structure or configuration for rotating the two optical discs. The Document by no means refers to recording information on information recording areas of both the information recording medium for hologram and the conventional optical disc and/or reproducing the information recorded on the information recording area, either.

### SUMMARY OF THE INVENTION

The present invention has been made in the light of the circumstances as above and it is an object of this invention to provide an optical information recording and/or reproducing apparatus which can, by the same apparatus, record information on both of an information recording area of an information recording medium for hologram and an information recording area of an existing optical disc represented by BD, DVD and CD and/or can reproduce the information recorded on both the information recording areas.

To accomplish the above object, according to the present invention, an optical information recording and/or reproducing apparatus for recording information on an optical information recording medium and/or reproducing the information recorded on the optical information recording medium by mean of an optical pickup, the optical information recording medium including an information recording medium for hologram and an optical disc adapted to record and/or reproduce information during its high-speed rotation, comprises a hologram information recording medium drive motor adapted to drive the information recording medium for hologram and an optical disc drive motor adapted to drive the optical disc.

Also, according to an embodiment of the present invention, in an optical information recording and/or reproducing apparatus for recording information on an information recording medium and/or reproducing the information recorded on the optical information recording medium by means of an optical pickup, the optical information recording medium includes an information recording medium for hologram and an optical disc adapted to record and/or reproduce information during its high-speed rotation and the optical pickup is arranged on a stage movable in X-axis direction and Y-axis direction orthogonal thereto.

In the present invention, a medium on which information is recorded by utilizing holography, a medium from which the information recorded by utilizing holography is reproduced and a medium which undergoes recording and reproduction are generally termed “an information recording medium for hologram” and a medium on which information is recorded during high-speed rotation, a medium from which the recorded information is reproduced during high-speed rotation and a medium which undergoes recording and reproduction during high-speed rotation as typified by BD, DVD, CD and the like are generally termed “an optical disc”.

According to this invention, there can be provided an optical information recording and/or reproducing apparatus which can, by the same apparatus, record information on both of an information recording area of an information recording medium for hologram and an information recording area of an existing optical disc typified by BD, DVD and CD and/or can reproduce the information recorded on both the information recording areas.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating a schematic configuration of an embodiment of a drive constituting an optical information recording and/or recording apparatus according to the present invention.

FIG. 2 is a diagram illustrating an example of an optical system of an optical pickup constituting the optical information recording and/or reproducing apparatus shown in FIG. 1.

FIG. 3 is a block diagram illustrating a schematic configuration of another embodiment of the drive constituting the optical information recording and/or reproducing apparatus according to the invention.

FIG. 4 is a diagram illustrating a schematic configuration of an embodiment of motors and optical pickup constituting the optical information recording and/or reproducing apparatus according to the invention.

FIG. 5 is a diagram illustrating a schematic configuration of another embodiment of the motors and optical pickup constituting the optical information recording and/or reproducing apparatus according to the invention.

FIG. 6 is a diagram illustrating a schematic configuration of still another embodiment of the motor and optical pickup constituting the optical information recording/reproducing apparatus according to the invention.

### DESCRIPTION OF THE INVENTION

Preferred embodiments of an optical information recording and/or reproducing (hereinafter simply referred to as recording/reproducing) apparatus according to the present invention will now be described with reference to the accompanying drawings. The embodiments to be described hereinafter are mere examples for explaining the present invention and this invention is in no way limited to these embodiments. Accordingly, the present invention can be carried out in various forms without departing from the gist of this invention.

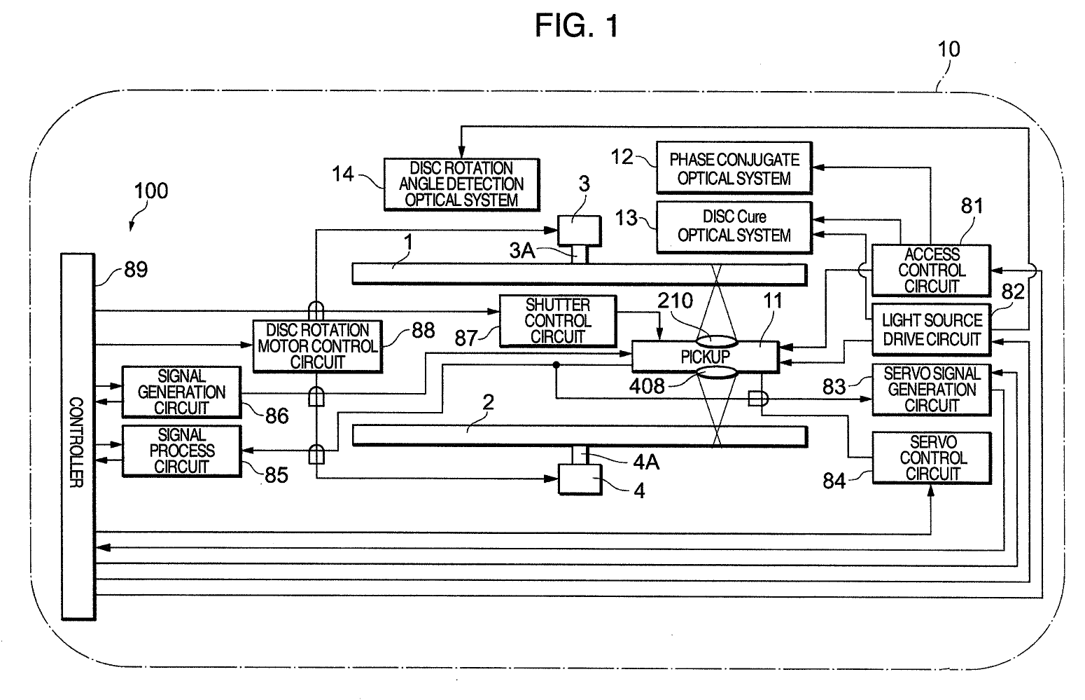

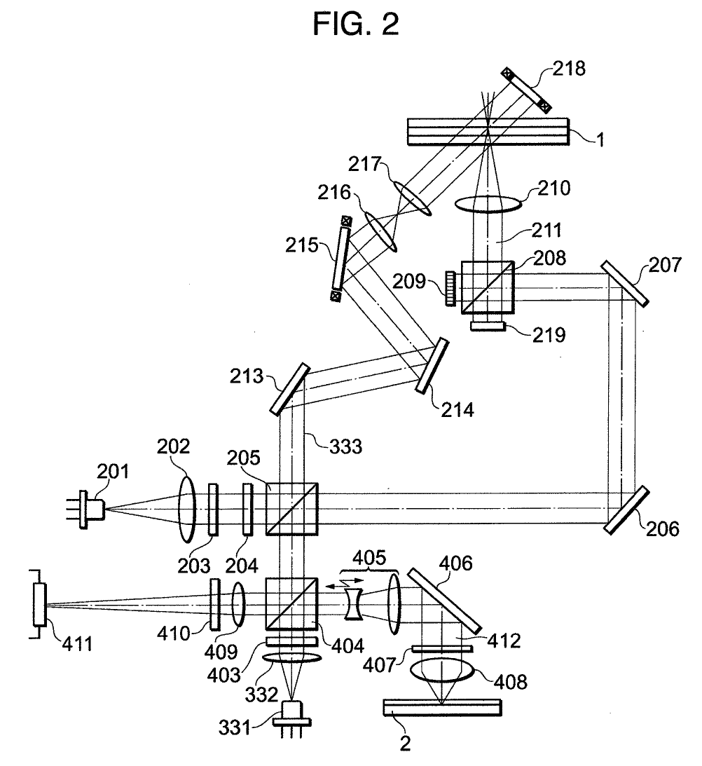

Reference will first be made to FIG. 1 schematically illustrating an embodiment of a drive constituting the optical information recording/reproducing apparatus according to the invention and then FIG. 2 illustrating an example of an optical system of an optical pickup constituting the optical information recording/reproducing apparatus shown in FIG. 1.

As shown in FIG. 1, an optical information recording/reproducing apparatus 10 embodying the present invention comprises a stepping motor 3 adapted to mount a hologram memory disc 1 as an information recording medium for hologram and rotate it, a DC motor 4 adapted to mount such an optical disc 2 for recording and/or reproducing information during its high-speed rotation as typified by BD, DVD, CD and so on, an optical pickup 11 for admitting a laser beam to each of the hologram memory disc 1 and optical disc 2 to perform recording/reproduction of information, a phase conjugate optical system 12, a disc cure optical system 13, an optical system 14 for detection of disc rotation angle and a control unit 100 for controlling these components.

The stepping motor 3 has a clamp portion for removably chucking the hologram memory disc 1, the DC motor 4 has a clamp portion for removably chucking the optical disc 2 and they are arranged to oppose to each other, permitting the clamp portions to face each other. More particularly, the hologram disc 1 is mounted to the stepping motor 3 on the side thereof confronting the DC motor 4 and the optical disc 2 is mounted to the DC motor 4 on the side thereof confronting the stepping motor 3. In the present embodiment, the stepping motor 3 and DC motor 4 are so arranged as to enable a rotary shaft 3A of stepping motor 3 and a rotary shaft 4A of DC motor 4 to align on the same straight line.

At least part of the clamp portion of stepping motor 3 is formed of a magnet. Then, in a portion of hologram memory disc 1 to be held by the clamp portion, an area is formed which is made of a metal to be attracted by the magnet. With this structure, even when the hologram memory disc 1 mounted to the stepping motor 3 underlies the stepping motor 3 as shown in FIG. 1, the hologram memory disc 1 can be held by the clamp portion while being attracted by the magnet and so can be prevented more steadily from being dropped.

The optical pickup 11 is interposed between the stepping motor 3 and the DC motor 4. The optical pickup 11 is movable along a guide shaft not shown and shares operations of recording information in an information recording area of the hologram memory disc 1 mounted to the stepping motor 3 and in an information recording area of the optical disc 2 mounted to the DC motor 4 and reproducing the recorded information. The optical pickup 11 includes an objective lens 210 for focusing a light beam on the hologram memory disc 1 and an objective lens 408 for focusing a light beam on the optical disc 2. The objective lens 210 is so arranged as to confront the hologram memory disc 1 and the objective lens 408 is so arranged as to confront the optical disc 2.

In performing recording/reproduction on/from the hologram memory disc 1, the optical pickup 11 emits a reference light beam and a signal light beam to the hologram memory disc 1 to record digital information on the basis of holography. At that time, an information signal to be recorded is sent under the command of a controller 89 to a space light modulator 209 (see FIG. 2) to be described later inside the optical pickup 11 through a signal generation circuit 86 and a signal light beam is modulated by the space light modulator 209. Illumination time of the reference beam and signal beam which are irradiated on the hologram memory disc 1 can be adjusted by controlling, via a shutter control circuit 87, open/close time of a shutter 203 (see FIG. 2) to be described later inside the optical pickup 11 under the command of the controller 89.

When reproducing information recorded on the hologram memory disc 1, a phase conjugate light beam of the reference beam emitted from the optical pickup 11 is generated by the phase conjugate optical system 12. The phase conjugate light beam referred to herein means a light wave propagating in a direction reverse to the incident direction while keeping the same wave front as the input light beam. A reproduction light beam reproduced by the phase conjugate beam is detected with a photodetector 219 (see FIG. 2) to be described later inside the optical pickup 11 and a signal is reproduced with the help of a signal process circuit 85.

In order to complete the aforementioned recording and reproduction through one revolution of the hologram memory disc, the hologram memory disc 1 is rotated by means of the stepping motor 3. With a view to obtaining optical energy sufficient to stably record information on the hologram memory disc 1, it is preferable that the hologram memory disc 1 is still as recording and reproduction of information proceeds. Accordingly, in the present embodiment, the stepping motor 3 capable of operating rotation/stop of the hologram memory disc 1 stably is used for this purpose.

The disc cure optical system 13 is adapted to generate an optical beam used for pre-cure and post-cure of the hologram memory disc 1. The pre-cure is a pre-step employed, during recording information at a desired position on the hologram memory disc 1, for irradiating a predetermined optical beam beforehand in advance of the irradiation of reference light beam and signal light beam at the desired position. The post-cure is a post-step of irradiating a predetermined optical beam at the desired position to make direct read after write impossible after the information has been recorded at the desired position inside the hologram memory disc 1.

The disk rotation angle detection optical system 14 is adapted to detect the rotation angle of the hologram memory disc 1. When adjusting the hologram memory disc 1 to a predetermined rotation angle, a signal corresponding to the rotation angle of hologram memory disc 1 is detected with the disc rotation angle detection optical system 14 and the controller 89 uses the detected signal to control the rotation angle of hologram memory disc 1 through a disc rotation motor control circuit 88.

Each of the optical pickup 11, disc cure optical system 13 and disc rotation angle detection optical system 14 has its internal light source which is supplied with a predetermined light source drive current from a light source drive circuit 82, thus enabling the individual light sources to emit optical beams of predetermined quantities of light.

Further, each of the optical pickup 11, phase conjugate optical system 12 and disc cure optical system 13 is provided with a mechanism which can slide the position of each component in the radial direction of the hologram memory disc 1 so that the position of each component may be controlled through an access control circuit 81. This position control allows recording and reproduction to be carried out over the entire surface of the disc.

On the other hand, when the optical pickup 11 performs recording on the optical disc 2, a signal light beam is emitted to the optical disc 2 mounted to the DC motor 4 to record information. An information signal to be recorded is sent to the optical pickup 11 through the signal generation circuit 86 under the command of the controller 89, and a signal light beam is focused as a light spot on the optical disc 2 by means of the objective lens 408 (focusing lens) and the information is recorded.

Further, when reproducing the information recorded on the optical disc 2, a reflection beam from the optical disc 2 is converted by the optical pickup 11 into an electric signal which in turn is transmitted to the signal process circuit 85, thus completing reproduction. In the recording and reproduction described as above, focusing of the optical spot on the optical disc 2 (auto-focus) and positioning onto a track (guide groove), that is, tracking are carried out through a servo signal generation circuit 83 and a servo control circuit 84.

In the recording/reproduction of information on/from the optical disc 2, the optical disc 2 needs to be rotated at a high speed of several thousands rpm for the purpose of obtaining a high transfer speed of several hundreds bps. To this end, in the present embodiment, as a motor for driving the optical disc 2, the DC motor 4 capable of rotating the optical disc 2 stably at high speeds is used.

The control unit 100 includes the aforementioned access control circuit 81, light source drive circuit 82, servo signal generation circuit 83, servo control circuit 84, signal process circuit 85, signal generation circuit 86, shutter control circuit 87, disc rotation motor control circuit 88 and controller 89.

For example, when, in the optical information recording/reproducing apparatus 10, the stepping motor 3 and DC motor 4 are connected to the controller 89 and if the hologram memory disc 1 is mounted on the stepping motor 3, a signal to this effect is transmitted to the controller 89 and if the optical disc 2 is mounted to the DC motor 4, a signal to this effect is also transmitted to the controller 89. Then, the controller 89 switches the optical path as will be described later on the basis of the transmitted signal to permit the light beam to be incident upon either one of the objective lens 210 and objective lens 408, thus making a decision as to whether recording or reproduction of information proceeds on or from the hologram memory disc 1 or on or from the optical disc 2. Alternatively, a switch indicating that information is to be recorded on the hologram memory disc 1, a switch indicating that the information recorded on the hologram is to be reproduced, a switch indicating that information is to be recorded on the optical disc 2 and a switch indicating that the information recorded on the optical disc 2 is to be reproduced may be provided for the optical information recording/reproducing apparatus 10 and the user may turn on a desired one of the switches to determine the contents of process.

To miniaturize the optical information recording/reproducing apparatus 10, some or whole of the optical system structure of the optical pickup 11, phase conjugate optical system 12, disc cure optical system 13 and disc rotation angel detection optical system 14 may be unified and simplified. Since the recording technique utilizing the holography is a technique capable of recording information in super-high density, the tolerable errors in inclination and positional offset or deviation of the hologram memory disc 1 tend to be extremely small. Therefore, for example, a servo mechanism may be adopted in the optical information recording/reproducing apparatus 10 by providing, in the optical pickup 11, a mechanism for detecting an amount of deviation of the small tolerable error deviation factor such as inclination and positional deviation of the hologram memory disc 1 so that a signal for servo control may be generated in the servo signal generation circuit 83 and the deviation amount may be corrected through the servo control circuit 84.

Next, optical operation when the optical pickup 11 records a signal on the hologram memory disc 1 or reproduces information recorded on the hologram memory disc 1 through the use of holography and optical operation when the optical pickup 11 records information on the optical disc 2 or reproduces the information recorded on the optical disc 2 will be described by making reference to FIG. 2.

When recording a signal on the hologram memory disc 1 or reproducing the information recorded on the hologram memory disc 1 through holography, a light beam emitted from a laser light source 201 capable of emitting a light beam of high interference nature is used as a signal light beam and a reference light beam as well. When recording information on the optical disc 2 or reproducing the information recorded thereon, a laser light source 331 that emits a light beam of lower interference nature than the laser light source 201 is used aiming at suppression of the laser noise.

Recording on the hologram memory disc 1 is accomplished as will be described below. Firstly, a light beam emitted from the light source 201 transmits through a collimate lens 202 and enters the shutter 203. With the shutter 203 opened, the light beam passes through the shutter 203, its polarization direction is then controlled by an optical element 204 comprised of, for example, a ½ wavelength plate such that the ratio between light quantities of P and S polarized light beams can be a desired value and thereafter, the resulting beam enters a PBS prism 205. The optical path of a light beam having transmitted through the PBS prism 205 is changed by means of reflection mirrors 206 and 207 to reach a PBS prism 208 and the light beam is admitted to the space light modulator 209 by way of the PBS prism 208. Then, a signal light beam 211 added with information by the space light modulator 209 is focused on the hologram memory disc 1 by means of the objective lens 210.

On the other hand, a light beam reflected from the PBS prism 205 acts as a reference light beam 333 which in turn enters a lens 216 by way of mirrors 213 and 214 and a galvanomirror 215. The lens 216 plays the role of focusing the reference light beam on a back focal plane of a lens 217, so that the reference light beam once focused on the back focal plane of lens 217 is again collimated thereby so as to be incident on the hologram memory disc 1. Here, the galvanomirror 215 is a rotatable mirror and through the rotation, the incident angle of the reference light beam 333 coming to the hologram memory disc 1 can be set to a desired angle.

By causing the signal light beam and the reference light beam to be incident on the hologram memory disc 1 in a mutually overlapping fashion, an interference fringe pattern can be formed in the hologram memory disc 1 and by writing this pattern in an information recording area, the information can be recorded. Further, the reference light beam incident on the hologram memory disc 1 can be changed in its incident angle by rotating the galvanomirror 215 and therefore, recording based on angular multiplex can be assured.

Next, when reproducing the information recorded on the hologram memory disc 1, only the reference light beam 333 is caused to enter the hologram memory disc 1 and a light beam having transmitted through the hologram memory disc 1 is reflected by means of a galvanomirror 218, thereby forming its phase conjugate light beam. A reproduction light beam reproduced on the basis of the phase conjugate light beam transmits through the objective lens 210 and PBS prism 208 to come to the photodetector 219, so that the recorded signal can be reproduced.

In the present embodiment, an instance is taken where the signal light beam and the reference light beam come to the hologram memory disc 1 by way of the separate lenses but a system may be adopted in which a single objective lens is provided and signal and reference light beams enter the single objective lens and then are irradiated on the disc.

On the other hand, when recording information on the optical disc 2 or reproducing the information recorded on the optical disc 2, a laser beam emitted from the laser light source 331 is used. Firstly, the light beam emitted from the light source 331 transmits through a collimate lens 332 to reach a polarization direction conversion element 403. In the polarization direction conversion element 403, a polarized beam outgoing from this element is so controlled in polarization direction as to be an S polarized beam, so that the light beam incident on a PBS prism 404 can be reflected thereby and guided to an optical path of a beam expander 405. Subsequently, a light beam having transmitted through the beam expander 405 is placed in circularly polarized condition after being routed through a start-up mirror 406 and an optical element 407 comprised of, for example, ¼ wavelength plate and thereafter it enters the objective lens 408 so as to be focused on an information recording area (information recording surface) of the optical disc 2, thus completing recording of the information.

Then, a light beam reflected by the optical disc 2 propagates on an optical path inverse to the aforementioned going path to route through the objective lens 408, optical element 407, start-up mirror 406 and beam expander 405 and transmits through the PBS prism 404. A light beam having transmitted through the PBS prism 404 transmits through a lens 409 and is then diffractively separated to a desired light beam by means of a detection side diffraction grating 410 with a view to permitting detection of information signal and a desired servo signal, and thereafter focused on a photodetector 411.

As described above, by switching (selecting) either the emission of a beam from the laser light source 201 or the emission of a light beam from the laser light source 331, that is, by causing the light beam to be selectively incident on either the objective lens 210 or the objective lens 408, the optical pickup 11 determines the medium for recording or reproduction of information.

The present embodiment has been described by referring to the case where when recording a signal on the hologram memory disc 1 or reproducing the information recorded on the hologram memory disc 1 through holography, the light beam emitted from the laser light source 201 that emits a light beam of high interference nature is used as a signal light beam and a reference light beam as well and the case where when recording information on the optical disc 2 or reproducing the information recorded on the optical disc 2, the laser light source 331 for emitting a light beam of lower interference nature than that from the laser light source 201 is used; but this is not limitative and by controlling the irradiation light quantity by combinations of the polarization direction conversion element 403 and PBS prism 404, a choice can be made as to whether the light beam emitted from the laser light source 331 is irradiated as a light beam for cure on the hologram memory disc 1 or irradiated on the optical disc 2 as a light beam for recording or reproduction on or from the optical disc 2.

Reasons for this are as follows. Generally, as the signal light beam and reference light beam, a light beam of high interference nature such as a wavelength variable laser beam is demanded from the standpoint of holography whereas as the light beam for cure, a light beam of low interference nature is demanded in order not to form an unwanted hologram responsible for a cause of noise from a view point of signal quality. Accordingly, the light beam emitted from the laser light source 331 of low interference nature can be used as the light beam for cure. In this case, the polarization direction conversion element 403 can be adjusted by, for example, inserting or drawing out a liquid crystal device or a waveform plate. Then, the light beam for cure routes through the collimate lens 332 and polarization direction conversion element 403 and thereafter transmits through the PBS prisms 404 and 205, thus being irradiated on the hologram memory disc 1 through the same path as that for the reference light beam.

The present embodiment has been described by way of example of the use of the disc-shaped hologram memory disc 1 as the information recording medium for hologram but this is not limitative and the information recording medium for hologram may be shaped differently, for example, by taking a card form. In this case, it is preferable that the information recording medium for hologram is not rotatable but is movable in X-axis direction and in Y-axis direction orthogonal thereto by means of, for example, a stepping motor. In case the information recording medium for hologram has a shape other than the disc form, the optical pickup can be provided with a mechanism for moving the optical pickup in X-axis direction and Y-axis direction so that while keeping the information recording medium for hologram stationary, the optical pickup may be moved to arbitrary positions in the X-axis and Y-axis directions to perform recording and reproduction of information. In this construction, for movement of the optical pickup in the X-axis and Y-axis directions, a stepping motor, for example, can be used.

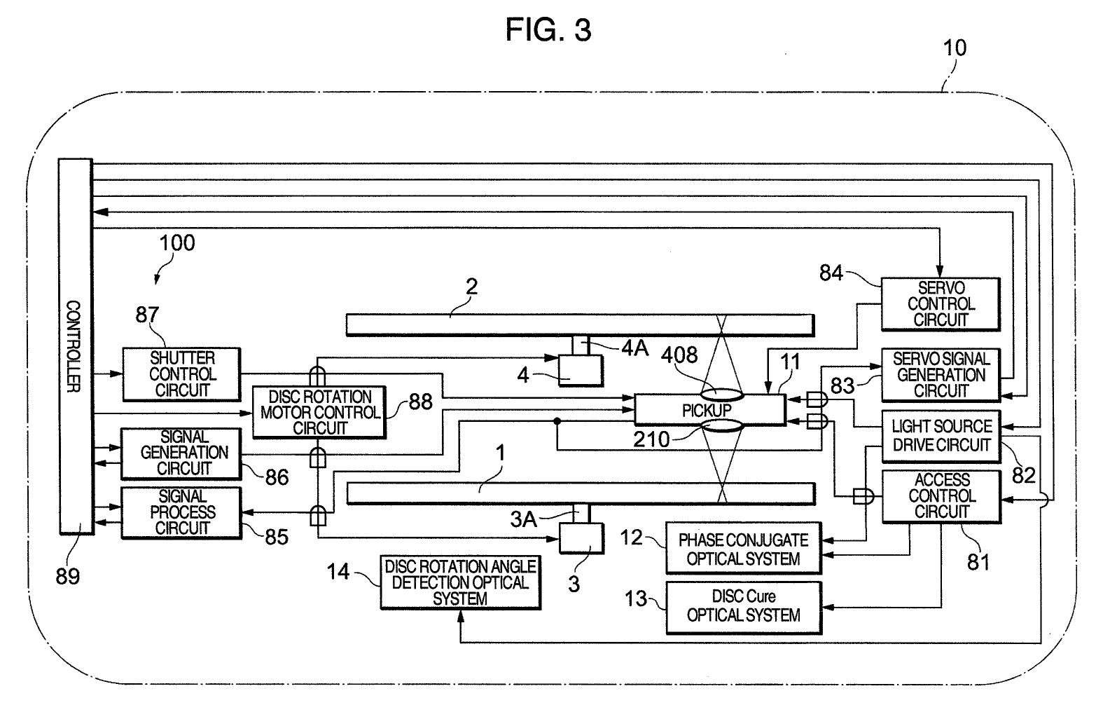

It will be appreciated that in the present embodiment, the hologram memory disc 1 and optical disc 2 are arranged to oppose each other with intervention of the optical pickup 11 and this arrangement is particularly preferable when miniaturization of the optical information recording/reproducing apparatus 10 is considered. In the case of this arrangement, the positional relationship among the hologram memory disc 1, optical disc 2, stepping motor 3 and DC motor 4 can be changed (exchanged) arbitrarily, provided that the hologram memory disc 1 is mounted to the stepping motor 3 and the optical disc 2 is mounted to the DC motor 4. For example, as shown in FIG. 3, the position of stepping motor 3 may be exchanged with the position of DC motor 4, with the clamp portion of DC motor 4 laid on the upper side. In this construction, the hologram memory disc 1 can be supported from below by means of the stepping motor 3 and the optical disc 2 can also be supported from below by means of the DC motor 4 and therefore, the clamp portion may dispense with the magnet.

Structurally, in the conventional optical disc apparatus, it is general that the optical disc 2 is carried on a tray so as to be inserted in the apparatus and the optical disc 2 is then chucked from below. At that time, since the label surface of optical disc 2 overlies, the rotary motor and optical pickup are positioned below the disc. Namely, for recording and reproduction of information, a laser beam needs to be emitted from below the optical disc 2. If following the conventional type optical disc insertion method as above, the aforementioned arrangement as shown in FIG. 3 is preferable.

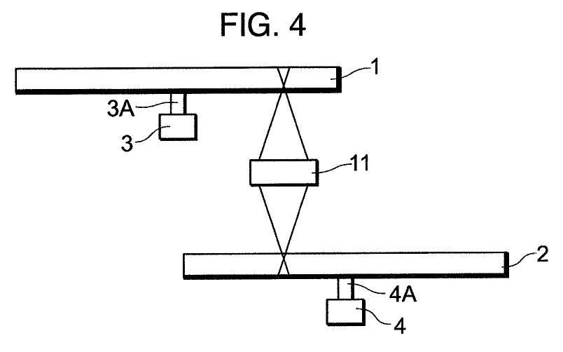

Further, in the present embodiment, the stepping motor 3 and DC motor 4 are described as being arranged such that the rotary shaft 3A of stepping motor 3 and the rotary shaft 4A of DC motor 4 are aligned on the same straight line but this is not limitative and, for example, the rotary shaft 3A of stepping motor 3 may be staggered from the rotary shaft 4A of DC motor 4 as shown in FIG. 4. In this case, the hologram memory disc 1 mounted to the stepping motor 3 and the optical disc 2 mounted to the DC motor 4 are spaced apart to oppose to each other but their surfaces may not overlap wholly with each other but may overlap partly with each other.

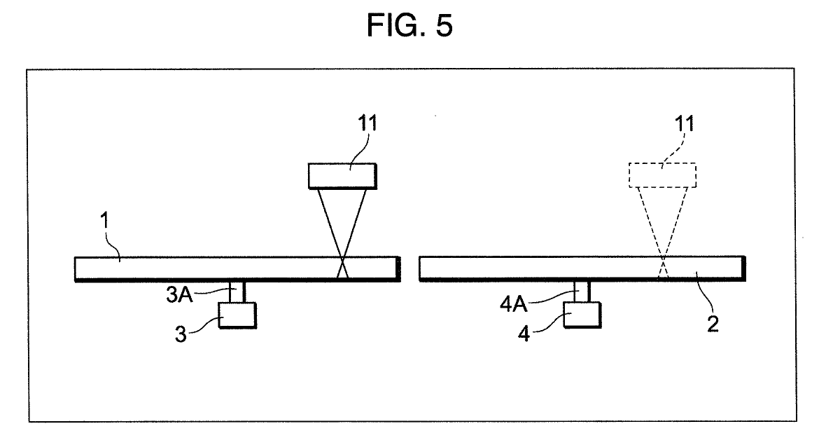

Further, the stepping motor 3 and DC motor 4 may be arranged in such a manner that the mounted hologram memory disc 1 and optical disc 2 are juxtaposed in the radial direction as shown in FIG. 5. With this configuration, the thickness of the drive can be reduced as compared to the configuration where the stepping motor 3 overlaps the DC motor 4. In this configuration, too, recording and reproduction of information on and from each of the hologram memory disc 1 and optical disc 2 can be performed with the single optical pickup 11.

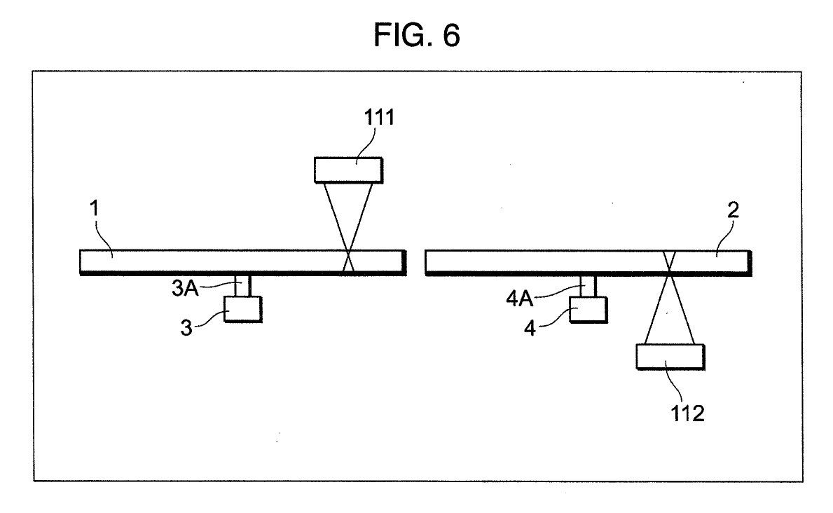

Furthermore, the present embodiment has been described as causing the single optical pickup 11 to perform recording and reproduction of information on and from each of the hologram memory disc 1 and optical disc 2 but this is not limitative and for example, as shown in FIG. 6, an optical pickup 111 for performing recording and reproduction of information on and from the hologram memory disc 1 and an optical pickup 112 for performing recording and reproduction on and from the optical disc 2 may be arranged. In this configuration, recording and reproduction of information in association with the hologram memory disc 1 and recording and reproduction of information in association with the optical disc 2 can be carried out in parallel. Accordingly, such a multitask that for example, information recorded on the optical disc 2 is reproduced during recording of information on the hologram memory disc 1 or different pieces of information are recorded on the hologram memory disc 1 and optical disc 2, respectively, in parallel can be realized.

The foregoing embodiments have been described as arranging the stepping motor 3 and DC motor 4 such that the hologram memory disc 1 mounted on the stepping motor 3 and the optical disc 2 mounted on the DC motor 4 are held horizontally but this is not limitative and in accordance with the size and shape and modeling such as vertical or horizontal type of the optical information recording/reproducing apparatus 10, the hologram memory disc 1 mounted to the stepping motor 3 and the optical disc 2 mounted to the DC motor 4 may be arranged so as to be held in vertical or inclined state.

It should be further understood by those skilled in the art that although the foregoing description has been made on embodiments of the invention, the invention is not limited thereto and various changes and modifications may be made without departing from the spirit of the invention and the scope of the appended claims.

1. An optical information recording and/or reproducing apparatus for recording information on an optical information recording medium and/or reproducing the information recorded on the optical information recording medium, said optical information recording medium including an information recording medium for hologram and an optical disc for performing recording and/or reproduction of information during its high-speed rotation, comprising:
a hologram information recording medium drive motor adapted to drive said information recording medium for hologram; and
an optical disc drive motor adapted to drive said optical disc.

2. An optical information recording and/or reproducing apparatus according to claim 1, wherein said hologram information recording medium drive motor is a stepping motor and said optical disk drive motor is a DC motor.

3. An optical information recording and/or reproducing apparatus according to claim 1, wherein said information recording medium for hologram is shaped to take a disc form.

4. An optical information recording and/or reproducing apparatus according to claim 1, wherein said information recording medium for hologram and said optical disc are arranged to oppose to each other.

5. An optical information recording and/or reproducing apparatus according to claim 1, wherein said information recording medium for hologram is shaped to take a disc form and is arranged to confront said optical disc and wherein said hologram information recording medium drive motor includes a clamp portion for removably mounting said hologram information recording medium and at least part of said clamp portion is formed of a magnet to be able to attract said hologram information recording medium.

6. An optical information recording and/or reproducing apparatus according to claim 1, wherein said optical pickup is provided by one and by means of said single optical pickup, information is recorded on both said information recording medium for hologram and said optical disc and/or the information recorded on both said information recording medium for hologram and said optical disc is reproduced therefrom.

7. An optical information recording and/or reproducing apparatus according to claim 6, wherein said optical pickup includes a lens for hologram information recording medium adapted to focus a light beam on said hologram information recording medium and a lens for optical disc adapted to focus a light beam on said optical disc, and the light beam emitted from a light source is selectively incident upon any one of said lens for hologram information recording medium and said lens for optical disc so as to determine the optical information recording medium on and/or from which information is recorded and/or reproduced.

8. An optical information recording and/or reproducing apparatus according to claim 1, wherein said hologram information recording medium drive motor is carried on a stage which is movable in X-axis direction and in Y-axis direction orthogonal to the X-axis direction.

9. An optical information recording and/or reproducing apparatus for recording information on an optical information recording medium and/or reproducing the information recorded on the optical information recording medium,
wherein said optical information recording medium includes an information recording medium for hologram and an optical disc for performing recording and/or reproduction of information during its high-speed rotation, and said optical pickup is carried on a stage which is movable in X-axis direction and in-Y axis direction orthogonal to the X-axis direction.

10. An optical information recording and/or reproducing apparatus according to claim 9, wherein said information recording medium for hologram and said optical disc are arranged to oppose to each other.

11. An optical information recording and/or reproducing apparatus according to claim 9 further comprising a DC motor for rotating said optical disc, wherein said information recording medium for hologram is kept stationary.

12. An optical information recording and/or reproducing apparatus according to claim 11, wherein said optical pickup is provided by one and by means of said single optical pickup, information is recorded on both said information recording medium for hologram and said optical disc and/or the information recorded on both said information recording medium for hologram and said optical disc is reproduced therefrom.

13. An optical information recording and/or reproducing apparatus according to claim 12, wherein said optical pickup includes a lens for hologram information recording medium adapted to focus a light beam on said hologram information recording medium and a lens for optical disc adapted to focus a light beam on said optical disc, and the light beam emitted from a light source is selectively incident upon any one of said lens for hologram information recording medium and said lens for optical disc so as to determine the optical information recording medium on and/or from which information is recorded and/or reproduced.

14. A drive capable of mounting an information recording medium for hologram and a DVD, comprising:
an optical pickup having an optical system for emitting laser beams;
a stepping motor for driving said information recording medium for hologram; and
a DC motor for driving rotation of said DVD.
